(19) United States
(12) Patent Application Publication
(10) Pub. No.: US 2020/0057896 A1
(43) Pub. Date: Feb. 20, 2020

(54) VEHICLE RISK RECOGNITION AND AVOIDANCE

(71) Applicant: Intel Corporation, Santa Clara, CA (US)

(72) Inventor: Daniel POHL, Puchheim (DE)

(21) Appl. No.: 16/583,277

(22) Filed: Sep. 26, 2019

(51) Int. Cl. G06K 9/00; G08G 1/16; G05D 1/02

(52) U.S. Cl. CPC G06K 9/00805; G06K 9/00798; G06K 9/00369; G05D 2201/0213; G08G 1/166; G05D 1/0238; G05D 1/0214; G08G 1/164

(57) ABSTRACT

A risk detection and avoidance device comprises one or more image sensors, configured to provide image sensor input data representing a sensor image of a vicinity of the device; and one or more processors, configured to detect from the image sensor data an overpass and one or more persons on the overpass; determine from the image sensor data a falling-object probability associated with the detected one or more persons on the overpass, according to a first logic; determine from the image sensor data one or more falling-object evasion factors associated with a vicinity of the device; and if the falling-object probability exceeds a predetermined threshold, determine a harm avoidance maneuver based at least on the one or more falling-object evasion factors, according to a second logic, and send an instruction comprising the harm avoidance maneuver.

### TECHNICAL FIELD

Various aspects relate generally to vehicle detection of risk factors within a vicinity of a vehicle and actions to avoid harm corresponding to the risk.

### BACKGROUND

Vehicles encounter various dangerous situations during travel. Often these dangers are preceded by observable situations or anomalies that may indicate an increased risk. As social science focuses more on these situations, specific events or observable occurrences with statistical relationships to increased likelihood of harm are being identified. These events or observable occurrences may be both qualifiable and quantifiable. As such, these events may be subject to algorithmic analysis, with an aim of calculating a probability of an action or resulting harm, such that, if warranted, evasive measures may be taken in an attempt to avoid the harm.

One such example of harmful events with related, observable occurrences that may indicate an increased likelihood of harm involves objects being dropped or thrown from overpasses. This may include, for example, people throwing rocks or bricks from overpasses above a roadway. Such falling objects may result in direct harm, for example, by crashing through a windshield and physically injuring or killing a driver. These falling objects may also result in harm by damaging a vehicle such that it becomes undriveable or uncontrollable, and thus creates a collision or injury. These falling objects may alternatively or additionally result in a driver's shock or fright, such that a collision or injury becomes more likely to occur. Anecdotally, objects being dropped or thrown onto a roadway from an overpass appears to occur frequently, such that this may occur daily or even multiple times daily throughout the world.

Various efforts have been made to prevent objects from being thrown or dropped from an overpass to a roadway. Primarily, physical barriers, such as fences, walls, or shields, have been erected, such that it becomes more difficult to physically throw an object from an overpass onto traffic below. Nevertheless, considering the number of overpasses, physical barriers may be an expensive and impractical solution on a wide scale.

### BRIEF DESCRIPTION OF THE DRAWINGS

Throughout the drawings, it should be noted that like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1 shows a vehicle configured to obtain image sensor data of a vicinity of the vehicle;

FIG. 2 shows a plurality of positions associated with an overpass;

FIG. 3 shows the attribution of risk points according to an aspect of the disclosure;

FIG. 4 shows an assessment of risk evasion strategies relative to a perceived risk;

FIG. 5 shows a method of risk detection and avoidance; and

FIG. 6 depicts a risk detection and avoidance device, according to an aspect of the disclosure.

### DESCRIPTION

The following detailed description refers to the accompanying drawings that show, by way of illustration, specific details and aspects in which the disclosure may be practiced. These aspects are described in sufficient detail to enable those skilled in the art to practice the disclosure. Other aspects may be utilized and structural, logical, and electrical changes may be made without departing from the scope of the disclosure. The various aspects are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa.

The word “exemplary” is used herein to mean “serving as an example, instance, or illustration”. Any aspect or design described herein as “exemplary” is not necessarily to be construed as preferred or advantageous over other aspects or designs.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The words “plural” and “multiple” in the description and the claims expressly refer to a quantity greater than one. Accordingly, any phrases explicitly invoking the aforementioned words (e.g., “a plurality of (objects)”, “multiple (objects)”) referring to a quantity of objects expressly refers more than one of the said objects. The terms “group (of)”, “set (of)”, “collection (of)”, “series (of)”, “sequence (of)”, “grouping (of)”, etc., and the like in the description and in the claims, if any, refer to a quantity equal to or greater than one, i.e. one or more.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data,” however, is not limited to the aforementioned examples and may take various forms and represent any information as understood in the art.

The term “processor” as, for example, used herein may be understood as any kind of entity that allows handling of data. The data may be handled according to one or more specific functions executed by the processor. Further, a processor as used herein may be understood as any kind of circuit, e.g., any kind of analog or digital circuit. The term “handle” or “handling” as for example used herein referring to data handling, file handling or request handling may be understood as any kind of operation, e.g., an I/O operation, and/or any kind of logic operation. An I/O operation may include, for example, storing (also referred to as writing) and reading.

A processor may thus be or include an analog circuit, digital circuit, mixed-signal circuit, logic circuit, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

Differences between software and hardware implemented data handling may blur. A processor, controller, and/or circuit detailed herein may be implemented in software, hardware and/or as hybrid implementation including software and hardware.

The term “system” (e.g., a computing system, a control system, etc.) detailed herein may be understood as a set of interacting elements, wherein the elements can be, by way of example and not of limitation, one or more mechanical components, one or more electrical components, one or more instructions (e.g., encoded in storage media), and/or one or more processors, and the like.

As used herein, the term “memory”, and the like may be understood as a non-transitory computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa.

The term “vehicle” as used herein may be understood as any suitable type of vehicle, e.g., any type of ground vehicle, a watercraft, an aircraft, or any other type of vehicle. In some aspects, the vehicle may be a motor vehicle (also referred to as automotive vehicle). As an example, a vehicle may be a car also referred to as a motor car, a passenger car, etc. As another example, a vehicle may be a truck (also referred to as motor truck), a van, etc.

The term “lane” with the meaning of a “driving lane” as used herein may be understood as any type of solid infrastructure (or section thereof) on which a vehicle may drive. In a similar way, lanes may be associated with aeronautic traffic, marine traffic, etc., as well.

According to various aspects, information (e.g., obstacle identification information, obstacle condition information, etc.) may be handled (e.g., processed, analyzed, stored, etc.) in any suitable form, e.g., data may represent the information and may be handled via a computing system. The obstacle condition may be used herein with the meaning of any detectable characteristic of the obstacle itself and/or associated with the obstacle. As an example, in the case that the obstacle is a vehicle, a driver, a passenger, a load, etc., the obstacle may be associated with the vehicle. A risk that originates from a person or object that is associated with the obstacle, may be treated in the analysis (as described herein) as a risk potential assigned to the obstacle.

In some aspects, one or more range imaging sensors may be used for sensing obstacles and/or persons and/or objects that are associated with an obstacle in the vicinity of the one or more imaging sensors. A range imaging sensor may allow associating range information (or in other words distance information or depth information) with an image, e.g., to provide a range image having range data associated with pixel data of the image. This allows, for example, for providing a range image of the vicinity of a vehicle including range information about one or more objects depicted in the image. The range information may include, for example, one or more colors, one or more shadings associated with a relative distance from the range image sensor, etc. According to various aspects, position data associated with positions of objects relative to the vehicle and/or relative to an assembly of the vehicle may be determined from the range information. According to various aspects, a range image may be obtained, for example, by a stereo camera, e.g., calculated from two or more images having a different perspective. Three-dimensional coordinates of points on an object may be obtained, for example, by stereophotogrammetry, based on two or more photographic images taken from different positions. However, a range image may be generated based on images obtained via other types of cameras, e.g., based on time-of-flight (ToF) measurements, etc. Further, in some aspects, a range image may be merged with additional sensor data, e.g., with sensor data of one or more radar sensors, etc.

In one or more aspects, a driving operation (such as, for example, any type of safety operation, e.g., a collision avoidance function, a safety distance keeping function, etc.) may be implemented via one or more on-board components of a vehicle. The one or more on-board components of the vehicle may include, for example, one or more cameras (e.g., at least a front camera) and a computer system, etc., in order to detect obstacles (e.g., at least in front of the vehicle) and to trigger an obstacle avoidance function (e.g., braking, etc.) to avoid a collision with the detected obstacles. The one or more on-board components of the vehicle may include, for example, one or more cameras (e.g., at least a front camera) and a computer system, etc., in order to detect another vehicle (e.g., at least in front of the vehicle) and to follow the other vehicle (e.g., autonomously) or at least to keep a predefined safety distance with respect to the other vehicle.

In various aspects, a depth camera (or any other range image device) may be used, for example, aligned at least in the forward driving direction to detect during driving when an obstacle may come too close and would cause a collision with the vehicle. In a similar way, at least one depth camera (or any other range image device) may be used, for example, that is aligned in the rear driving direction to avoid a collision in the case that an obstacle approaches from this direction.

According to various aspects, a voxel map may be used to describe objects in the three dimensional space based on voxels associated with objects. To detect objects, follow objects, or otherwise based on a voxel map, ray-tracing, ray-casting, rasterization, etc., may be applied to the voxel data.

As an example, a depth image may include information to indicate a relative distance of objects displayed in the image. This distance information may be, but is not limited to, colors and/or shading to depict a relative distance from a sensor. Positions of the objects may be determined from the depth information. Based on depth images, a two dimensional map or a three dimensional map may be constructed from the depth information. The map construction may be achieved using a depth map engine, which may include one or more processors or a non-transitory computer readable medium configured to create a pixel or voxel map (or any other suitable map) from the depth information provided by the depth images. According to various aspects, a depth image may be obtained by a stereo camera, e.g., calculated from two or more images having a different perspective. Further, a depth image may be generated by any suitable one or more sensors (e.g. a laser scanner, etc.) that may allow for a correlation of position information and distance (depth) information.

According to various aspects, a map may be used to store position information and/or the ambient condition information in a suitable form of data that allows controlling one or more operations of the unmanned aerial vehicle based on the map. However, other suitable implementations may be used to allow control of the unmanned aerial vehicle based on at least the movement data.

According to various aspects, one or more sensors and a computing system may be used to implement the functions described herein. The computing system may include, for example, one or more processors, one or more memories, etc. The computing system may be communicatively coupled to the one or more sensors (e.g., of a vehicle) to obtain and analyze sensor data generated by the one or more sensors. According to some aspects, the one or more processors may be configured to generate depth images in real-time from the data received from one or more range imaging sensors and analyze the depth image to find one or more features associated with conditions that represent a risk potential.

Several aspects are described herein exemplarily with reference to a motor vehicle, wherein one more other vehicles represent obstacles in a vicinity of the motor vehicle. However, other types of vehicles may be provided including the same or similar structures and functions as described exemplarily for the motor vehicle. Further, other obstacles may be considered in a similar way as described herein with reference to the other vehicles.

Various aspects of the principles, devices, and procedures described herein may utilize one or more processors to perform an age recognition function. This may be performed by artificial intelligence, a process, or otherwise. Various commercially available, proprietary, and open source systems for recognition of age are currently available. Any artificial intelligence system for age recognition may be used.

Various aspects of the principles, devices, and procedures described herein may utilize detected position information, such as a position value of a vehicle with respect to Earth, in combination with one or more data sources including position information of one or more overpasses, to locate the vehicle relative to an overpass. That is, using the position information corresponding to a position of the vehicle, and using the position data associated with a position of the overpass, the one or more processors may determine a distance between the vehicle and an overpass. Various systems (commercial, open-source, or otherwise) offer position information of roadways, bridges, overpasses, and the like. Any such system may be utilized for the steps disclosed herein, without limitation.

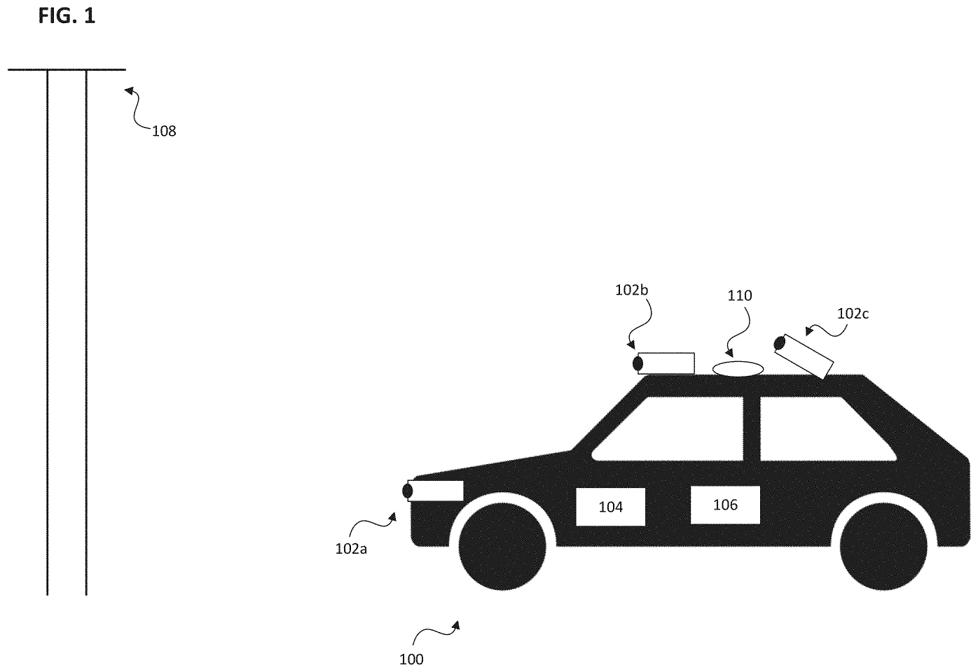

FIG. 1 depicts a vehicle 100 configured with one or more image sensors 102a, 102b, and 102c, which may be configured to receive image sensor information from a vicinity of the vehicle and to convert the image sensor information into image sensor data, which may be then provided to one or more processors 104 for further processing. The one or more processors 104 may be configured to utilize one or more processes, one or more artificial intelligences, and/or one or more databases, tables, or other information sources stored in one or more memories 106. The vehicle may be configured with one or more position sensors 110, which may be configured to obtain position sensor information from one or more position sources, and to detect a position of the vehicle using the received position sensor information. The one or more position sensors 110 may be configured to provide detected position information to the one or more processors 104, which may be configured to carry out one or more processes using the detected position.

The vehicle 100, during travel, may encounter various situations which may represent an increased risk of harm. One such situation, for example, may be driving in the vicinity of an overpass 108. An overpass may be understood as any structure above a roadway. The overpass may span a gap above a roadway. The overpass may be configured as a bridge, whether a vehicle bridge, a pedestrian bridge, or otherwise.

It is known, for example, that persons may throw or drop objects from an overpass onto a vehicle or roadway below. In this case, the image sensors 102a, 102b, and 102c mounted to the vehicle 100 may be configured to receive sensor information from a vicinity of the vehicle, including an overpass 108. The one or more processors 104 which receive corresponding sensor data, may be configured to analyze the sensor data to determine the presence of one or more risk factors, to make a risk determination based on the risk factors, and potentially to take action to evade or diminish the risk.

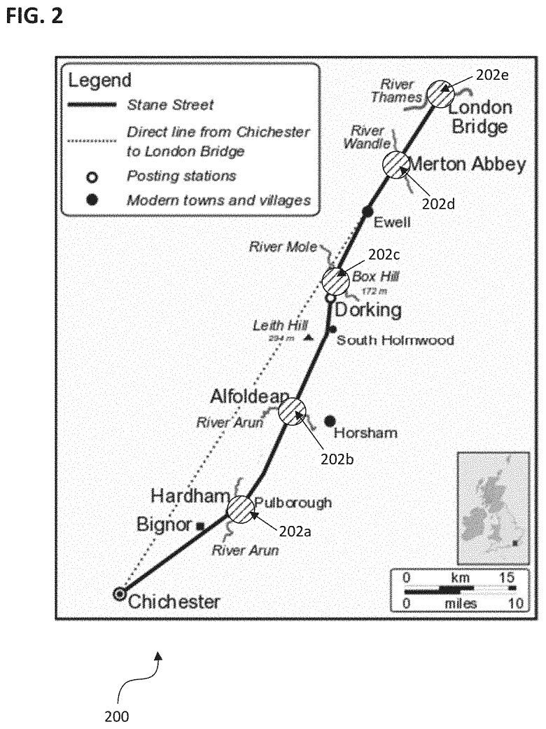

FIG. 2 depicts a map corresponding to a stored database of locations of overpasses. Rather than causing the one or more processors to constantly analyze image sensor data for overpasses in order to perform the procedures described herein, it may be desirable to perform the analyses described herein only when the vehicle is in a vicinity of an overpass. This may be determined, for example, based on position sensor information, rather than a constant search and analysis of image sensor data. Sufficiently accurate geographic positions of roadways relative to the earth are generally known and are stored within a plurality of commercially or publicly available databases. Many vehicles are currently configured with navigation systems that utilize one or more of said databases along with position sensor information to determine a position of the vehicle relative to a roadway or various features along the roadway. For example, FIG. 2 depicts a map 200 of a roadway which spans a plurality of bodies of water 202a, 202b, 202c, 202d, and 202e. At each of these intersections between the roadway and a body of water, one or more bridges and/or one or more overpasses may be present. The locations of such overpasses may be known and stored within one or more databases, such that a vehicle with a position sensor and access to the one or more databases may compare the determined position sensor information with stored locations of overpasses and, based on this information, determine when the vehicle is within a vicinity of an overpass. Furthermore, the overpasses may be associated with one or more roadways or directions, such that the vehicle may be able to determine from two or more positions a roadway on which the vehicle is traveling relative to the overpass. Otherwise stated, the vehicle may be able to determine whether it will be traveling on or below the overpass. The one or more processors of the vehicle may be configured to perform these determinations during vehicle travel based at least one position sensor information and one or more sources of stored data including locations of overpasses. The one or more processors may be configured to perform the methods and procedures described herein when the vehicle reaches a predetermined proximity to a known overpass, a predetermined travel duration from a known overpass, or any other relationship to a known overpass. In this manner, the methods and procedures described herein may be implemented when a predetermined relationship between the vehicle and an overpass is established, and thus a need to consistently analyze image sensor data for an overpass may be avoided. According to another aspect of the disclosure, the one or more processors may be configured to constantly or periodically analyze image sensor data for the presence of an overpass, without respect to vehicle position or vehicle position sensor information.

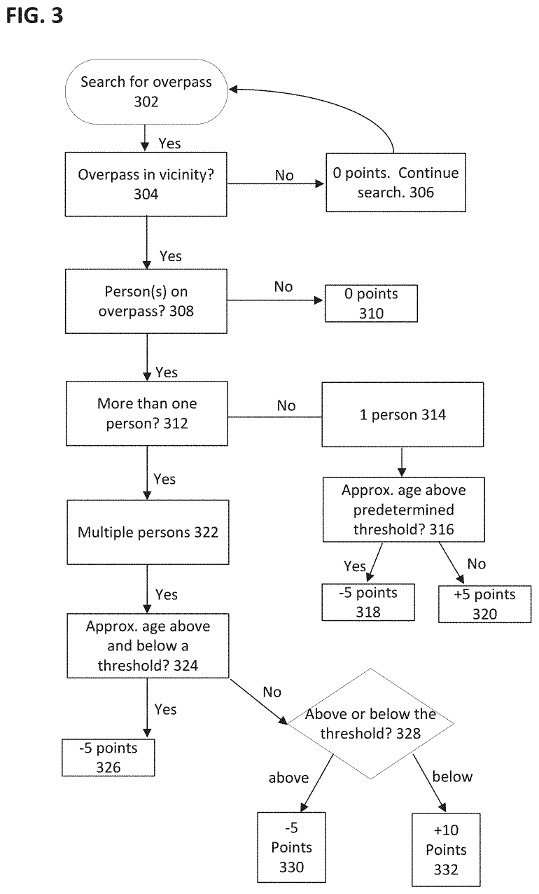

FIG. 3 depicts a potential decision tree for determining a number of points corresponding to a risk from persons on an overpass. This decision tree is provided as an example but is in no way intended to be limiting. Various studies have been performed, and continue to be performed, to identify characteristics or motives of persons who have thrown objects from an overpass. Some of these studies have identified various characteristics which may indicate an increased likelihood that a person on an overpass may throw or drop an object from the overpass onto oncoming traffic. Data from such studies, and/or from any other source, may be used to design a decision tree or process to evaluate risk from persons on an overpass. These decision trees or processes may be altered or refined as additional information becomes known to better evaluate risk.

As an example, a decision tree or process may be designed based on current information related to the demographics of persons who are more likely to throw or drop an object from an overpass. For example, some statics indicate that that younger persons are more likely to throw objects from an overpass than older persons, and that groups of persons of mixed-age groups (some generally older, some generally younger) may be less likely to throw or drop an object from an overpass than groups of only younger persons.

Given this scenario, the vehicle may be configured to search for an overpass 302. The search for an overpass may be performed according to any procedure or process. As described herein, the vehicle may be equipped with one or more position sensors to determine a position of the vehicle, and the determined position may be used in conjunction with a database or other information source containing positions of known overpasses, to determine whether the vehicle is in a vicinity of an overpass. When a relationship between the vehicle and the overpass exceeds a predetermined threshold, the procedures described herein may be activated. According to another aspect of the disclosure, the one or more processors may be configured to analyze image sensor data to determine the presence of an overpass, such as by looking for structures above the roadway. The specifics of how to recognize an overpass above a roadway from image data will be known by a person skilled in the art and will not be detailed herein.

Based on the method of searching for an overpass as described above, the one or more processors may determine whether an overpass is in a vicinity of the vehicle 304. If there is no overpass, then no points are awarded and the vehicle may be instructed to continue the search for an overpass 306. If an overpass is in a vicinity of the vehicle, the one or more processors may analyze image sensor data to determine whether one or more persons are on the overpass 308. If no persons are on the overpass, the danger of objects being thrown from the overpass is effectively zero, and no points are awarded 310. If one or more persons are on the overpass, then it may be determined how many persons are on the overpass, or at least whether the number of persons exceeds one 312. If there is only one identified person, then the approximate age of the identified person may be determined 316. If the approximate age is above a predetermined threshold, then a number of points may be subtracted from the risk assessment 318, as older persons made be generally less likely to throw objects from an overpass. If the approximate age is beneath a predetermined threshold, then a number of points may be added to the risk assessment 320. If multiple persons are detected on the overpass 322, it may be determined whether the approximate ages of the persons are beneath a threshold, above a threshold, or, in the case of a mixed-age group, both above and below a threshold. One method of doing so may be to first determine whether the group includes one or more persons whose approximate ages are below the threshold and one or more persons whose approximate ages are above the threshold 324. In this case, points may be subtracted from the risk assessment 326. If the approximate ages of the persons in the group fall only above or only below the threshold, then it may be determined where the ages lie with respect threshold 328. If the persons in the group are older than the predetermined threshold, then points may be subtracted 330. If they are younger than the predetermined threshold, then points may be added 332. The number of points selected the stages may be weighted depending on the relative risk. For example, because the highest likelihood of danger in this scenario arises from multiple young persons together, the satisfaction of these criteria may be associated with a higher risk, as is indicated by the +10 points, as opposed to other criteria, which may add, e.g., five or even fewer points.

The number of steps in the analysis provided herein is provided merely as an example. The steps may be fewer or greater, as desired. The decision tree or process may take into account fewer or more factors, as desired. It is anticipated, that as additional studies are performed, more information will be known about the perpetrators of actions such as throwing objects from an overpass, and accordingly alternative or more detailed decision trees or algorithms may be created to evaluate risk as additional information becomes available.

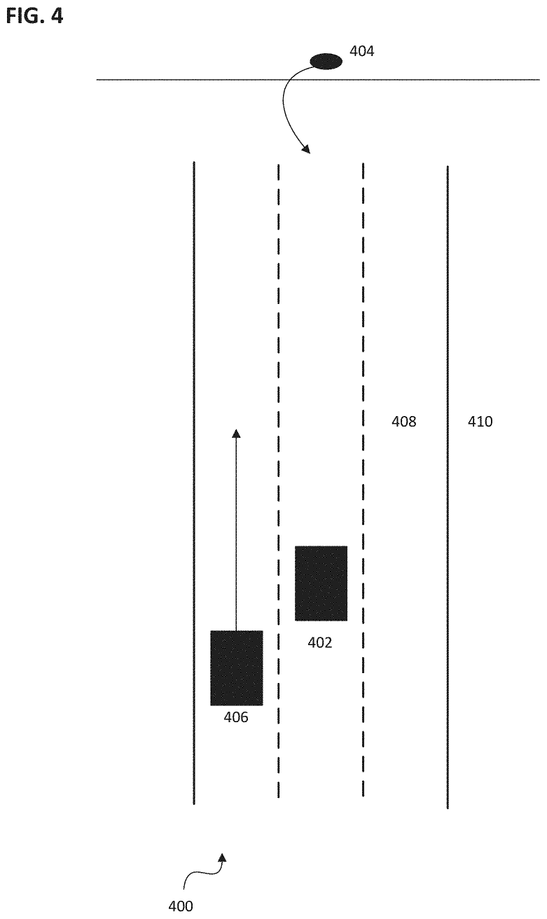

Once a level of risk is determined, various actions may be taken to attempt to prevent collision or injury. FIG. 4 depicts a number of such possible actions. In this figure, a three lane roadway running beneath an overpass 400 is depicted. Located in the middle lane, vehicle 402 determines that it is within a vicinity of an overpass and performs an analysis to determine a potential likelihood of an object being dropped or thrown from the overpass onto the oncoming traffic lanes. Based on the results of this analysis, vehicle 402 determines that there is a sufficiently high probability of an object being thrown or dropped from the overpass that it must further investigate options for evading a falling object and, if possible, it must select or undertake one of these options. In this hypothetical example, vehicle 402 has identified one or more persons on the overpass at location 404 who have a sufficiently high likelihood of dropping or throwing an object. Vehicle 402 calculates that an object dropped or thrown from one or more persons 404 may have a high likelihood of landing in the middle lane of traffic where vehicle 402 is traveling.

Vehicle 402 may evaluate potential options of evading the danger of a falling object from the one or more persons 404. First, if vehicle 402 continues to travel within the middle lane, it may place itself in the path of the falling object. Vehicle 402 may next evaluate the possibility of changing lanes from the center lane to the left lane. The vehicle may use any number of its sensors to determine whether a change of lane into the left lane may be possible. In this case, vehicle 402 will discover that vehicle 406 is occupying the left lane and traveling at a velocity that is likely to make it dangerous or impossible for vehicle 402 to travel to the left lane. Under this circumstance, vehicle 402 may evaluate switching to the right lane 408. In this case, the right lane is free, and vehicle 402 may opt to change lanes into the right lane to avoid a potential falling object 404 into the center lane. Alternatively, vehicle 402 may travel to a shoulder 410, where the vehicle may come to arrest to avoid a falling object.

Although the evasion principles described herein have been described with respect to a potential of a falling object, they may also be employed based on an actual detected falling object. That is, if an object is detected as having been dropped or thrown along the path indicated by 404, vehicle 402 may take any action to avoid collision with the following object, or to reduce the likelihood of collision with the following object. According to one aspect of the disclosure, such evasive actions may include, but are not limited to, changing lanes, traveling to: a shoulder of the road, increasing or decreasing velocity, increasing or decreasing acceleration, stopping, or otherwise.

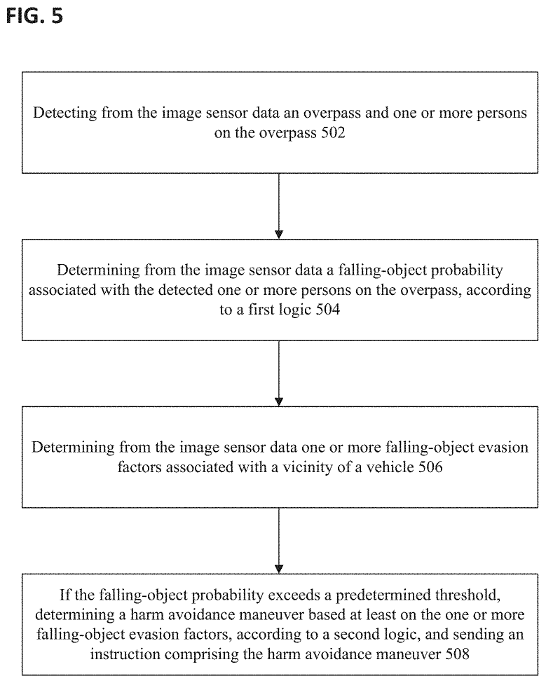

FIG. 5 depicts a method of risk detection and avoidance, including detecting from the image sensor data an overpass and one or more persons on the overpass 502; determining from the image sensor data a falling-object probability associated with the detected one or more persons on the overpass, according to a first logic 504; determining from the image sensor data one or more falling-object evasion factors associated with a vicinity of a vehicle 506; and if the falling-object probability exceeds a predetermined threshold, determining a harm avoidance maneuver based at least on the one or more falling-object evasion factors, according to a second logic, and sending an instruction including the harm avoidance maneuver 508.

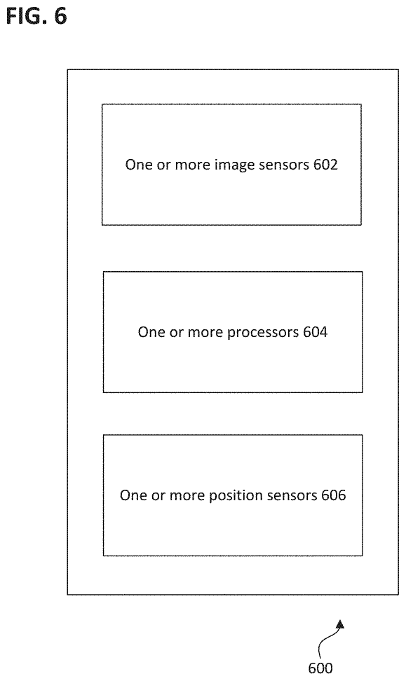

FIG. 6 depicts a risk detection and avoidance device 600, according to one aspect of the disclosure. The device may be configured with one or more image sensors 602, configured to provide image sensor input data representing a sensor image of a vicinity of the device; and one or more processors 604, configured to detect from the image sensor data an overpass and one or more persons on the overpass; determine from the image sensor data a falling-object probability associated with the detected one or more persons on the overpass, according to a first logic; determine from the image sensor data one or more falling-object evasion factors associated with a vicinity of the device; and if the falling-object probability exceeds a predetermined threshold, determine a harm avoidance maneuver based at least on the one or more falling-object evasion factors, according to a second logic, and send an instruction including the harm avoidance maneuver. The device may be further configured with one or more position sensors 606, configured to provide position sensor data representing a detected position of the device; wherein the one or more processors are configured to determine from the position sensor data and the database a proximity between the device and an overpass; detect from the image sensor data the overpass and one or more persons on the overpass; determine from the image sensor data a falling-object probability associated with the detected one or more persons on the overpass, according to a first logic; determine from the image sensor data one or more falling-object evasion factors associated with a vicinity of the device; and if the falling-object probability exceeds a predetermined threshold, determine a harm avoidance maneuver based at least on the one or more falling-object evasion factors, according to a second logic, and send an instruction including the harm avoidance maneuver.

According to one aspect of the disclosure, active scanning for people on bridges above streets may be undertaken. This may be performed with an estimation model of danger and possible methods to at least decrease the risk of impact between a thrown or dropped object from an overpass and a vehicle.

As a vehicle travels, the vehicle may utilize one or more front-facing cameras, or one or more cameras, which may obtain information from a forward region from the vehicle. In many modern vehicles, fully and/or partially front-facing cameras are commonly installed and may be routinely used to detect traffic signs or otherwise sense information in a vicinity of the vehicle. It is anticipated that the number of vehicles with front-facing cameras will increase, and these resulting technologies become more commonplace and robust.

The principles and methods described herein may be implemented, by one or more monoscopic and/or stereoscopic cameras, or any other vision sensor. For example, if stereoscopic cameras are used, distance information may be obtained in addition to data for identification of objects. That is, it may be possible with one or more stereoscopic cameras to determine a distance between the vehicle and the overpass, a distance between the vehicle and one or more hazards, a distance between the vehicle and one or more safe areas, or any combination thereof.

If two or more monoscopic cameras are used, the one or more processors may employ any of a variety of photogrammetry techniques for determining depth information from two or more overlapping images. In this manner, distance information may be detected and used much the same as with one or more stereoscopic cameras.

If a single monoscopic, front-facing camera is used, depth information may not be available from image data; however, the principles and methods described herein may be achieved with a combination of image data, position sensor data, and a data source for cross-referencing. For example, monoscopic camera data may be assessed for an overpass. Once an overpass is detected, the image data may not provide the necessary depth information to determine a distance between the vehicle and the overpass. The vehicle may, however, be configured with one or more position sensors, which may be configured to determine a position of the vehicle relative to a fixed point. Because the locations of nearly all overpasses are currently known, this position information may be compared to a data base or other data source in which the locations of overpasses are known. By cross-referencing these data, the one or more processors may determine a distance between the vehicle and the overpass that was detected in the monoscopic camera image data.

Assuming that image data is used to detect an overpass, the detection may be configured to begin with a predetermined distance from a known overpass location. For example, a vehicle may utilize a position sensor and data regarding the known positions of overpasses to determine a proximity between the vehicle and the overpass. Once an overpass is detected, image data may be further assessed to detect whether one or more persons are present on the overpass, and to evaluate various attributes and behaviors of the detected one or more persons. The predetermined distance may be any distance without limitation. According to one aspect of the disclosure, the predetermined distance may be 1 kilometer, 1 mile, or otherwise.

As an example, once an overpass is detected, image data including the overpass may be assessed to determine whether anything is moving on top of the overpass. The image data may be assessed to identify any one or more persons or objects on the overpass. For example, the image data may be assessed to determine whether one or more persons are present on the overpass. If one or more persons are detected, the image data may be further assessed to determine whether the one or more persons are individuals or distributed in groups, and/or whether each of the one or more persons are moving or stationary. Detected persons or objects may be further assessed to identify one or more pedestrians, one or more cyclists, one or more vehicles, or otherwise. If one or more persons are detected on the overpass, the image data may be further assessed to determine a number of detected persons on the overpass. They may be assessed to determine whether the persons are moving or stationary. Image data corresponding to detected persons may be further assessed to determine a direction that the persons are facing. That is, are the one or more persons facing in a direction of oncoming traffic, each other, away from traffic, or in any other direction.

Image data corresponding to detected persons may be further assessed to determine any factor desired. As nonlimiting examples, the image data may be assessed to determine whether the detected one or more persons are wearing masks, or otherwise disguising or covering their facial features. They may be assessed for wearing hats.

The one or more processors may be further configured to assess image data corresponding to one or more detected persons to estimate an age of the one or more detected persons. This may be performed based on any method, without limitation. According to one aspect of the disclosure, and artificial intelligence may be used to perform age assessment on image data. According to another aspect of the disclosure, the image data may be assessed by the one or more processors to approximate age based on any factor or combinations of factors that may be associated with age, such as, but not limited to, height, hair color, facial characteristics, or any other factors.

According to one aspect of the disclosure, the risk assessment may be carried out based on an accumulation of points. Each identified person may be considered to begin at an arbitrary number of points, from which points may be added or subtracted based on the presence or absence of factors associated with risk. The initial number of points awarded, whether zero, one hundred, fifty, or any other number, is primarily a matter of implementation, as the relative points awarded compared to the original number of points may primarily determine the risk level.

In an implementation that begins at zero points, each identified person on an overpass may begin with zero points and may be awarded points or have points deducted based on the determination of relative risk factors. As stated above, these risk factors may be customized for the various implementations. The risk factors for any given implementation may contain more or fewer risk factors than those disclosed or described herein. The risk factors described herein are provided as an example to indicate how risk factors may be structured in a given implementation. It is specifically contemplated that additional evidence or studies may become available, which bear light on the relevance of various risk factors, those known and perhaps those not yet discovered, and that the implementation may be customized to accommodate additional evidence or studies available in the future.

Points may additionally be assessed based on a location or one or more aspects of the overpass. For example, the presence of a fence, wall, or other barrier to prevent an object or being thrown or dropped onto oncoming traffic may reduce a number of points. Similarly, as these events may be less likely to occur in situations where the perpetrator is likely to be observed, identified, and/or caught, the risk of the occurrence may be lower. As such, a vicinity of the overpass may be evaluated for other traffic and/or observers, and the presence of other traffic and/or observers may correspond with a reduction of risk points.

As an example, and in an implementation in which each identified person on an overpass begins with zero points, points may be awarded or deducted, for example, based on the following factors:

| | | |
|---|---|---|
| No movement identified | 0 | points |
| Movement identified | | |
| ≥1 Pedestrians | +10 | points |
| Age | | |
| Above a threshold | −5 | points |
| Above and below a threshold | −5 | points |
| Only below threshold | +10 | points |
| Appearance | | |
| Masked/face not visible | +10 | points |
| ≥1 Cyclists | | |
| Traveling on bicycle | +1 | points |
| Stationary on bicycle | +10 | points |
| Presence of others | | |
| ≥1 other vehicles in vicinity | −5 | points |
| Fence, wall, or barrier | −20 | points |
| Detected falling objects | | |
| Object falling from overpass | +100 | points |

According to one aspect of the disclosure, various warning levels may be associated with ranges of points and with corresponding actions to be taken based on the warning level. The number of warning levels and the number of corresponding actions is a matter of input rotation, and may be configured based on any of a variety of factors. In theory, two or more warning levels may be implemented, such that one morning level corresponds to no danger or insufficient danger to implement any of the selected evasive actions, and the second warning level corresponds to higher danger sufficient to warrant any one or more evasive actions. The number of warning levels may be further selected to incorporate additional warning levels, such that a degree of acceptable evasive action may be tailored to the amount of risk.

For example, and according to one aspect of the disclosure, four warning levels may be selected as follows:

Warning level 0, likely no danger: 0-9 points

Warning level 1, probably no danger: 10-14 points

Warning level 2, maybe danger: 15-20 points

Warning level 3: definitively danger: >20 points

Based on the determined warning level, any of a variety of evasive actions may be undertaken.

A first potential evasive action may be to determine a statistically safest lane in which to proceed underneath an overpass. Depending on the roadway, a plurality of parallel lanes of traffic, moving in the same direction, may proceed underneath an overpass. As such, a driver traveling along one of these lanes of traffic may have the ability to change lanes or otherwise select a lane which is likely to represent a lower risk of harm than one of the other potential lanes of traffic. For example, if a particular person or group on the overpass is identified as having a higher statistical likelihood of throwing or dropping one or more objects from the overpass, it may be determined which of a plurality of lanes of traffic is directly below the person or group associated with the increased risk. If the vehicle is not currently traveling in this lane of traffic associated with the increased risk, the vehicle may proceed in its lane or in another lane that is also not associated with an increased risk. If, however, the vehicle is proceeding in the lane of traffic associated with increased risk, the vehicle may attempt to change lanes of traffic to enter a lane associated with a decreased or lower risk, to stop, or otherwise implement an evasive action.

Regarding the changing of lanes, various known techniques may be implemented for assessing the safety of a lane change. For example, the vehicle may be configured to identify one or more other vehicles and/or obstacles in adjacent lanes, and to make a lane changing decision based on the presence or absence of such vehicles and/or obstacles. Using a selected process for lane changing, and assuming that a lane associated with a lower risk than the lane in which the vehicle is currently traveling is available, the vehicle may attempt to change lanes from the current lane to the lane associated with a lower risk.

If a lane change is not possible, for example, such as when one or more vehicles or obstacles prevents a safe changing of lanes, and if the vehicle is traveling in a lane associated with a higher risk based on the risk factors described above, the vehicle may employ other strategies to attempt to reduce the risk of harm. For example, assuming that a person dropping or throwing an obstacle from an overpass does so not merely accidentally, but rather intends to strike an oncoming vehicle, it may be assumed that the person will throw or release the object based on a prediction of when a vehicle will reach a proximity to the overpass at which impact is likely to occur. A vehicle traveling in a lane of increased risk may frustrate this calculation by changing its velocity. That is, a person on an overpass attempting to calculate a time at which an object should be dropped or thrown from the overpass to strike an oncoming vehicle may be more likely to miscalculate the timing if the vehicle suddenly changes its velocity. For example, assuming no vehicles or obstacles directly in front of the vehicle at issue, and assuming a reasonable safety calculation relative to vehicles in neighboring lanes, the vehicle traveling in a lane associated with an increased risk of harm may accelerate with the intention of passing underneath the overpass before a person on the overpass can successfully drop or throw an object. Similarly, and assuming that an area behind the vehicle traveling in the lane of increased risk of harm is satisfactorily free of other vehicles and/or obstacles, the vehicle may rapidly decrease velocity such that a person seeking to drop or thrown object may miscalculate an drop or throw too soon for the object to reach the oncoming vehicle.

If the warning level is sufficiently great, or, for example, where the throwing or dropping of objects has been identified, it may be desired to take more extensive measures to evade impact with a falling object, such as:
Changing a lane of travel to a lane calculated as being less likely to be targeted.
Decreasing or increasing a velocity of the vehicle to make it more difficult for one or more persons dropping or throwing an object from an overpass to estimate when and where the vehicle will travel beneath the overpass.
If objects have previously been thrown from the overpass, follow the previously thrown objects over multiple frames and track their position and trajectories to estimate future attempts.
Travel to the shoulder or to a safety lane, and wait at that location until it can be determined that a danger from thrown or falling objects has passed and/or that the perpetrator or suspected perpetrator has left the area.
Depending on the local laws, the vehicle may inform police or other authority about that potential danger. Such tactics may result in the police arriving more rapidly to the scene and thus being better able to apprehend a suspect and/or prevent future harm.
Activate a video camera or save data from a video camera for delivery to police or other authority. For example, and with respect to police notification, the device may be configured to record a predetermined length of video upon detection of a risk above a predetermined threshold. Alternatively, the device may maintain a video ring buffer of a predetermined length. In this case, the device may be configured to constantly maintain a video of a set length, for example 30 seconds. If a risk above a predetermined threshold is detected, the video can be permanently stored or even wirelessly transmitted to the police or other authority. In this case, the vehicle may be configured with one or more transmitters or transceivers, and the one or more processors may be configured to control the one or more transmitters or transceivers to wirelessly transmit the video. Assuming no such threat is detected, the device may be configured to delete the video after a predetermined time. For example, the video may be on a loop such that any stored portion is overwritten every 30 seconds.

The principles described herein may be extended to apply to any detected increased risk, rather than specifically to an increased risk associated with a dropped or falling object from an overpass. In this manner, the principles and methods disclosed herein may be understood as a form of anomaly detection, wherein image sensor information is analyzed for characteristics associated with an increased risk, and based on one or more processes for assessing these characteristics, evasive action may be taken.

In a broader sense, the vehicle may be programmed with one or more assumptions about the operation of vehicles with respect to one another, and it may be configured to detect deviations from these assumptions, into attribute to any detected deviation a level of risk. By tallying the detected levels of risk, a decision may be reached about what, if any, evasive action to take.

As vehicles operate on a roadway, it is anticipated that the vehicles will adhere to each of a plurality of standards or norms for the operation of vehicles with respect to one another. The standards or norms may be observed standards or norms that are then programmed into the device as risk analysis criteria. Alternatively, the standards norms may be determined from laws, regulations, statutes, or otherwise, which specify any one or more behaviors for vehicles on a roadway. For example, the “rules of the road” for operation of vehicles may be reduced into one or more behaviors that may be generally expected from a vehicle. For example, vehicles on a roadway may be expected to:
operate at or within a given range outside of a posted speed limit;
move forward on a roadway in which forward travel is permitted (such as with a green light or the absence of a traffic control device) and the path of travel is not encumbered by a vehicle or obstacle;
avoid erratic turning or changing of lanes; and/or
avoid sudden braking.

The above assumptions are listed merely as examples, and the vehicle according to the aspects of this disclosure may be configured to operate in accordance with these assumptions, fewer than these assumptions and/or any additional or other assumptions.

As described with respect to the overpass, above, the one or more processors may be configured to utilize image sensor data to detect any deviations from the one or more assumptions related to vehicles on a roadway. Each deviation may be assigned a number of points, whether positive or negative, and points may be assessed for one or more situations to determine a risk level. Based on the determined risk level, one or more evasive actions may be taken.

The following is a non-exhaustive list of examples of deviations relative to assumed normal vehicle operational behavior.
One or more vehicles erratically change lanes. The erratic changing of lanes may occur without any identifiable reason, for which a first quantity of points may be assigned. Alternatively, the erratic changing of lanes may occur due to an identifiable reason (for example, avoidance of an obstacle) for which a second quantity of points may be assigned.
One or more vehicles may erratically brake or accelerate. If no cause of the erratic braking or acceleration can be determined, a first quantity of points may be assessed. If an identifiable cause of the erratic braking or acceleration can be determined, a second quantity of points may be assessed.
One or more pedestrians in the roadway. If one or more pedestrians are identified in a roadway, a first quantity of points may be assessed. This may be, generically, due to any person entering an area within the roadway. Alternatively, this may occur in high-pedestrian-traffic situations, such as prior to or following an event (concert, sporting game, etc.). In such a situation, a large number of pedestrians may be entering or leaving an area for the event, causing a large number of pedestrians to enter roadway. If the vehicle is in a parking lot, a large number of pedestrians may be walking through the parking lot, thereby warranting an increased measure of caution.

As a non-exhaustive list of examples, points may be assessed to the above situations as follows:

| | | |
|---|---|---|
| One or more vehicles quickly change lanes without an | +5 | points |
| identifiable reason: | | |
| One or more vehicles quickly change lanes with an | +10 | points |
| identifiable reason: | | |
| One or more vehicles suddenly brakes without an | +5 | points |
| identifiable reason: | | |
| One or more vehicles suddenly brakes with an | +10 | points |
| identifiable reason: | | |

| | |
|---|---|
| One or more vehicles operates significantly slower than | +5 points per |
| a permitted speed: | vehicle |

Based on the number of points accumulated, the vehicle may be configured to take one or more evasive actions including, but not limited to, reduction of speed, stopping, and/or traveling to an area of safety.

The one or more processors may be configured to detect from image sensor data the presence of one or more features that are associated with a risk. The detection of features may be performed according to any known image processing technique or techniques. The detection of features may be performed by a process, by artificial intelligence, or otherwise. The detection of features may be performed by one or more processors located in a vehicle, generally within a vicinity of the one or more image sensors, or remotely. For example, image data detected by the one or more image sensors may be transmitted to a server or other computational device for remote analysis. The results of said remote analysis may then be transmitted to the device.

The features to be detected from the image sensor data may be any number of features, without limitation. It is specifically anticipated that the features evaluated for may be selected based on any number of criteria including, but not limited to, any of processing capability, power supply, sociological data, statistical data, or any other criteria. A non-exhaustive list of features to be evaluated may include any of a number of persons on the overpass; whether the one or more persons are moving or stationary; a direction faced by the one or more persons relative to the device; an approximate age of any of the one or more persons; a proximity of at least two of the one or more persons; whether any of the one or more persons are wearing a hat; whether any of the one or more persons are wearing a mask; whether any of the one or more persons is riding a bicycle; or any combination of the foregoing; and wherein the one or more processors are configured to determine the falling-object probability using the determined risk factors.

The image sensors used may be any sensor whatsoever capable of detecting image sensor data from images in a vicinity of the image sensor. This may include, but is not limited to, any of one or more monovision cameras, one or more stereo cameras, one or more video cameras, one or more lidar sensors, one or more radar sensors, one or more ultrasound sensors one or more infrared sensors, or any other image sensor without limitation.

If one or more position sensors are used for the methods or principles described herein, the one or more position sensors may be any sensors whatsoever capable of detecting position information. This may include, but is not limited to position sensors configured to obtain position data from the Global Positioning System, the GLObal Navigation Satellite System (GLOBASS), Galileo, Beidou Navigation System, Indian Regional Navigation Satellite System, or any other positioning system. Alternatively or additionally, the one or more position sensors may be configured to detect position information from one or more wireless communication networks. That is, the one or more position sensors may be configured to detect one or more wireless telecommunication signals (Global System for Mobile Communication, 3g, LTE, 5G, or otherwise) and perform one or more localization techniques to determine a position. The details of such localization techniques may be known and therefore will not be recited in detail herein.

According to one aspect of the disclosure, and upon the one or more processors detecting one or more features associated with the risk, the features may be assigned one or more risk points. The risk points may utilize any point or weighting system, without limitation. The points may be positive or negative. The points may be integers, fractions, decimals or otherwise. The points may be organized, as generally depicted herein, to indicate a level of risk, such that a higher number of points corresponds to a higher level of risk. Alternatively, the points may be organized to indicate a level of safety, such that a lower number of points indicates higher risk, and higher number of points indicates higher safety.

Depending on the number of points, one or more risk levels may be determined. The system may be configured with any number of risk levels. According to one aspect of the disclosure, the risk levels may be binary, thereby indicating a low level of risk or a high level of risk. According to another aspect of the disclosure, three or more risk levels may be employed, such that the risk levels may have little risk, medium risk, and high-risk. Any number of intervening levels may be added, such that a corresponding plurality of evasion strategies becomes available. Each risk level may be assigned a range of risk points. The number or range of risk points associated with a risk level may be selected based on the implementation, without limitation. As a nonlimiting example, and in an implementation with three risk levels, a first level corresponding to a low risk may be associated with zero to twenty points; a second risk level associated within a medium level of risk may be associated with greater than twenty points to forty points; and a third level associated with a high level of risk may be associated with greater than forty points.

Depending on the level of risk, one or more evasion factors may be employed. The number and selection of evasion factors may be determined based on the implementation, depending on any of the environment in which a vehicle is traveling, the vehicle, the vehicle's safety features, a driver preference, behaviors of any neighboring vehicles, a proximity to the harm, or any other number of factors. According to one aspect of the disclosure, a non-exhaustive list of risk evasion factors may include any of determining a lane of traffic beneath at least one of the one or more persons on the overpass; an availability of an adjacent lane; a velocity of the device; an acceleration of the device; an availability of a road-shoulder or safety area; a velocity of each of one or more vehicles in a vicinity of the device; an acceleration of each of one or more vehicles in a vicinity of the device; or any combination thereof.

Depending on the level of risk and the availability of one or more evasion factors, one or more harm avoidance techniques may be employed. The harm avoidance techniques may be any action to reduce the likelihood of a vehicle encountering a risk or perceived harm. According to one aspect of the disclosure, a non-exhaustive list of harm avoidance techniques may include, but is not limited to, any of a change in velocity, acceleration, direction, or any combination thereof, to avoid an area below a person associated with a falling object probability above the predetermined threshold.

According to another aspect of the disclosure, the harm avoidance technique may be selected, at least in part, based on a risk of harm associated with the harm avoidance technique relative to a risk of harm calculated from one or more factors from the detected image sensor data. That is, a harm avoidance technique as an evasive action may itself be associated with a risk of harm. Sudden changes in velocity, changing of lanes, or other erratic behaviors may themselves subjective vehicle and/or driver to an increased risk of harm. The one or more processors may be configured to evaluate any such increased risk of harm with respect to a perceived risk of harm from a condition outside of the vehicle such as, but not limited to, the risk of a falling object from an overpass. The one or more processors may be configured with one or more processes or an artificial intelligence to evaluate the perceived risk of harm from a condition outside of the vehicle against a perceived risk of harm of a harm avoidance technique and to employ one or more harm avoidance techniques based on an overall reduced risk.

According to another aspect of the disclosure, the device may be configured to record and/or store video or image data for use as evidence with respect to a perceived risk of harm. In the event of a motor vehicle collision including, but not limited to, a collision between two or more motor vehicles, a collision between a falling object and one or more vehicles, a collision between a vehicle and one or more pedestrians, one or more legal or judicial processes may ensue for which evidence of the events and circumstances surrounding the incident may be of value. To that end, the device may utilize image or video data received from the one or more image sensors, or from one or more additional image sensors, and store such information for later use. According to one aspect of the disclosure, the device may be configured to trigger recording and storage of image or video data upon a perceived risk reaching a predetermined threshold. According to another aspect of the disclosure, the device may be configured to store a predetermined duration of image sensor data, such as an ongoing loop of image sensor data. In this manner, image sensor data corresponding to a time older than the predetermined duration may be overwritten. For example, the device may be configured to retain a loop of thirty seconds of image data, such that image data from the vehicle is automatically stored on a thirty second loop, and image sensor data older than thirty seconds is automatically overwritten. The one or more processors may be configured to identify a likely source of a risk and to control a camera or other image sensor device associated with the one or more image sensors to obtain image sensor data related to a cause of the perceived risk. For example, if one or more persons on an overpass are evaluated as posing an increased risk of dropping or throwing an object from the overpass, the one or more processors may control one or more cameras associated with the one or more image sensors to obtain image data of the one or more persons with an increased risk of dropping or throwing an object.

If an object falling from an overpass is detected, the one or more processors may be configured to control one or more transmitters to transmit video or image data of the following object to one or more authorities. This may include, but is not limited to, transmitting data to one or more police departments, to one or more emergency response teams, or otherwise.

Any of the methods disclosed herein may be configured as a vehicle or a device. Any device disclosed herein may be configured as a vehicle.

In the following, various examples are described that may refer to one or more aspects of the disclosure.

In Example 1, a risk detection and avoidance device is disclosed, including one or more image sensors, configured to provide image sensor input data representing a sensor image of a vicinity of the device; and one or more processors, configured to detect from the image sensor data an overpass and one or more persons on the overpass; determine from the image sensor data a falling object probability associated with the detected one or more persons on the overpass, according to a first logic; determine from the image sensor data one or more falling object evasion factors associated with a vicinity of the device; and if the falling object probability exceeds a predetermined threshold, determine a harm avoidance maneuver based at least on the one or more falling object evasion factors, according to a second logic, and send an instruction including the harm avoidance maneuver.

In Example 2, the risk detection and avoidance device of Example 1 is disclosed, wherein the one or more processors are further configured to detect from the image sensor data one or more of the following risk factors: a number of persons on the overpass; whether the one or more persons are moving or stationary; a direction faced by the one or more persons relative to the device; an approximate age of any of the one or more persons; a proximity of at least two of the one or more persons; whether any of the one or more persons are wearing a hat; whether any of the one or more persons are wearing a mask; whether any of the one or more persons is riding a bicycle; or any combination of the foregoing; and wherein the one or more processors are configured to determine the falling-object probability using the determined risk factors.

In Example 3, the risk detection and avoidance device of Example 2 is disclosed, wherein the first logic includes assigning a value to one or more of the risk factors and determining a falling object probability as a sum of the detected risk factors.

In Example 4, the risk detection and avoidance device of any one of Examples 1 to 3 is disclosed, wherein the one or more falling object evasion factors include one or more of determining a lane of traffic beneath at least one of the one or more persons on the overpass; an availability of an adjacent lane; a velocity of the device; an acceleration of the device; an availability of a road shoulder or safety area; a velocity of each of one or more vehicles in a vicinity of the device; an acceleration of each of one or more vehicles in a vicinity of the device; or any combination thereof.

In Example 5, the risk detection and avoidance device of any one of Examples 1 to 4 is disclosed, wherein the harm avoidance maneuver includes a change in velocity, acceleration, direction, or any combination thereof, to avoid an area below a person associated with a falling object probability above the predetermined threshold.

In Example 6, the risk detection and avoidance device of any one of Examples 1 to 5 is disclosed, wherein the second logic includes weighing falling object probability with at least one of a probability of harm associated with the harm avoidance maneuver; a probability of avoiding an area below a person associated with a falling object probability above the predetermined threshold if the harm avoidance maneuver is executed; or any combination thereof.

In Example 7, the risk detection and avoidance device of any one of Examples 1 to 6 is disclosed, wherein the one or more processors are further configured to store image data from the one or more image sensors if the falling object probability exceeds the predetermined threshold.

In Example 8, the risk detection and avoidance device of Example 7 is disclosed, wherein the one or more processors are further configured to store video data from the one or more image sensors if the falling object probability exceeds the predetermined threshold.

In Example 9, the risk detection and avoidance device of any one of Examples 1 to 8 is disclosed, wherein the one or more processors are further configured to detect an object falling from the overpass.

In Example 10, the risk detection and avoidance device of Example 8 is disclosed, wherein, if an object falling from the overpass is detected, the one or more processors are further configured to store image sensor data on a memory.

In Example 11, the risk detection and avoidance device of Example 8 is disclosed, wherein, if an object falling from the overpass is detected, the one or more processors are further configured to control a wireless communication device to contact an authority.

In Example 12, the risk detection and avoidance device of any one of Examples 1 to 11 is disclosed, further including one or more position sensors, configured to determine a position of the device and to send position data representing the detected position to the one or more processors; and a database including position information of one or more overpasses; wherein the one or more processors are configured to detect an overpass in a vicinity of the device based on a relationship between the position data from the one or more position sensors and the position information of the one or more overpasses.

In Example 13, the risk detection and avoidance device of Example 12 is disclosed, further including determining the falling object probability when a difference between the determined position of the device and the position information of an overpass is less than a predetermined threshold, and disabling determination of the falling object probability when a difference between the determined position of the device and the position information of an overpass is greater than a predetermined threshold.

In Example 14, a vehicle is disclosed, including one or more image sensors, configured to provide image sensor input data representing a sensor image of a vicinity of the vehicle; and one or more processors, configured to detect from the image sensor data an overpass and one or more persons on the overpass; determine from the image sensor data a falling object probability associated with the detected one or more persons on the overpass, according to a first logic; determine from the image sensor data one or more falling object evasion factors associated with a vicinity of the vehicle; and if the falling object probability exceeds a predetermined threshold, determine a harm avoidance maneuver based at least on the one or more falling object evasion factors, according to a second logic, and send an instruction including the harm avoidance maneuver.

In Example 15, the vehicle of Example 14 is disclosed, wherein the one or more processors are further configured to detect from the image sensor data one or more of the following risk factors: a number of persons on the overpass; whether the one or more persons are moving or stationary; a direction faced by the one or more persons relative to the vehicle; an approximate age of any of the one or more persons; a proximity of at least two of the one or more persons; whether any of the one or more persons are wearing a hat; whether any of the one or more persons are wearing a mask; whether any of the one or more persons is riding a bicycle; or any combination of the foregoing; and wherein the one or more processors are configured to determine the falling object probability using the determined risk factors.

In Example 16, the vehicle of Example 15 is disclosed, wherein the first logic includes assigning a value to one or more of the risk factors and determining a falling object probability as a sum of the detected risk factors.

In Example 17, the vehicle of any one of Examples 14 to 16 is disclosed, wherein the one or more falling object evasion factors include one or more of determining a lane of traffic beneath at least one of the one or more persons on the overpass; an availability of an adjacent lane; a velocity of the vehicle; an acceleration of the vehicle; an availability of a road shoulder or safety area; a velocity of each of one or more vehicles in a vicinity of the vehicle; an acceleration of each of one or more vehicles in a vicinity of the vehicle; or any combination thereof.

In Example 18, the vehicle of any one of Examples 14 to 17 is disclosed, wherein the harm avoidance maneuver includes a change in velocity, acceleration, direction, or any combination thereof, to avoid an area below a person associated with a falling object probability above the predetermined threshold.

In Example 19, the vehicle of any one of Examples 14 to 18 is disclosed, wherein the second logic includes weighing the falling object probability with at least one of a probability of harm associated with the harm avoidance maneuver; a probability of avoiding an area below a person associated with a falling object probability above the predetermined threshold if the harm avoidance maneuver is executed; or any combination thereof.

In Example 20, the vehicle of any one of Examples 14 to 19 is disclosed, wherein the one or more processors are further configured to store image data from the one or more image sensors if falling object probability exceeds the predetermined threshold.

In Example 21, the vehicle of Example 20 is disclosed, wherein the one or more processors are further configured to store video data from the one or more image sensors if the falling-object probability exceeds the predetermined threshold.

In Example 22, the vehicle of any one of Examples 14 to 21 is disclosed, wherein the one or more processors are further configured to detect an object falling from the overpass.

In Example 23, the vehicle of Example 22 is disclosed, wherein, if an object falling from the overpass is detected, the one or more processors are further configured to store image sensor data on a memory.

In Example 24, the vehicle of Example 22 is disclosed, wherein, if an object falling from the overpass is detected, the one or more processors are further configured to control a wireless communication vehicle to contact an authority.

In Example 25, the vehicle of any one of Examples 14 to 24 is disclosed, further including one or more position sensors, configured to determine a position of the vehicle and to send position data representing the detected position to the one or more processors; and a database including position information of one or more overpasses; wherein the one or more processors are configured to detect an overpass in a vicinity of the vehicle based on a relationship between the position data from the one or more position sensors and the position information of the one or more overpasses.

In Example 26, the vehicle of Example 25 is disclosed, further including determining the falling-object probability when a difference between the determined position of the vehicle and the position information of an overpass is less than a predetermined threshold, and disabling determination of the falling-object probability when a difference between the determined position of the vehicle and the position information of an overpass is greater than a predetermined threshold.

In Example 27, a risk detection and avoidance device is disclosed, including

one or more position sensors, configured to provide position sensor data representing a detected position of the device; one or more image sensors, configured to provide image sensor input data representing a sensor image of a vicinity of the vehicle; a database, including position data representing positions of one or more overpasses; and one or more processors, configured to determine from the position sensor data and the database a proximity between the device and an overpass; detect from the image sensor data the overpass and one or more persons on the overpass; determine from the image sensor data a falling-object probability associated with the detected one or more persons on the overpass, according to a first logic; determine from the image sensor data one or more falling-object evasion factors associated with a vicinity of the device; and if the falling-object probability exceeds a predetermined threshold, determine a harm avoidance maneuver based at least on the one or more falling-object evasion factors, according to a second logic, and send an instruction including the harm avoidance maneuver.

In Example 28, the risk detection and avoidance device of Example 27 is disclosed, wherein the one or more processors are further configured to detect from the image sensor data one or more of the following risk factors: a number of persons on the overpass; whether the one or more persons are moving or stationary; a direction faced by the one or more persons relative to the device; an approximate age of any of the one or more persons; a proximity of at least two of the one or more persons; whether any of the one or more persons are wearing a hat; whether any of the one or more persons are wearing a mask; whether any of the one or more persons is riding a bicycle; or any combination of the foregoing; and wherein the one or more processors are configured to determine the falling-object probability using the determined risk factors.

In Example 29, the risk detection and avoidance device of Example 28 is disclosed, wherein the first logic includes assigning a value to one or more of the risk factors and determining a falling-object probability as a sum of the detected risk factors.

In Example 30, the risk detection and avoidance device of any one of Examples 27 to 29 is disclosed, wherein the one or more falling-object evasion factors include one or more of determining a lane of traffic beneath at least one of the one or more persons on the overpass; an availability of an adjacent lane; a velocity of the device; an acceleration of the device; an availability of a road-shoulder or safety area; a velocity of each of one or more vehicles in a vicinity of the device; an acceleration of each of one or more vehicles in a vicinity of the device; or any combination thereof.

In Example 31, the risk detection and avoidance device of any one of Examples 27 to 30 is disclosed, wherein the harm avoidance maneuver includes a change in velocity, acceleration, direction, or any combination thereof, to avoid an area below a person associated with a falling-object probability above the predetermined threshold.

In Example 32, the risk detection and avoidance device of any one of Examples 27 to 31 is disclosed, wherein the second logic includes weighing falling-object probability with at least one of a probability of harm associated with the harm avoidance maneuver; a probability of avoiding an area below a person associated with a falling-object probability above the predetermined threshold if the harm avoidance maneuver is executed; or any combination thereof.

In Example 33, the risk detection and avoidance device of any one of Examples 27 to 32 is disclosed, wherein the one or more processors are further configured to store image data from the one or more image sensors if falling-object probability exceeds the predetermined threshold.

In Example 34, the risk detection and avoidance device of Example 33 is disclosed, wherein the one or more processors are further configured to store video data from the one or more image sensors if falling-object probability exceeds the predetermined threshold.

In Example 35, the risk detection and avoidance device of any one of Examples 27 to 34 is disclosed, wherein the one or more processors are further configured to detect an object falling from the overpass.

In Example 36, the risk detection and avoidance device of Example 35 is disclosed, wherein, if an object falling from the overpass is detected, the one or more processors are further configured to store image sensor data on a memory.

In Example 37, the risk detection and avoidance device of Example 35 is disclosed, wherein, if an object falling from the overpass is detected, the one or more processors are further configured to control a wireless communication device to contact an authority.

In Example 38, the risk detection and avoidance device of any one of Examples 27 to 37 is disclosed, further including one or more position sensors, configured to determine a position of the device and to send position data representing the detected position to the one or more processors; and a database including position information of one or more overpasses; wherein the one or more processors are configured to detect an overpass in a vicinity of the device based on a relationship between the position data from the one or more position sensors and the position information of the one or more overpasses.

In Example 39, the risk detection and avoidance device of Example 38 is disclosed, further including determining the falling-object probability when a difference between the determined position of the device and the position information of an overpass is less than a predetermined threshold, and disabling determination of the falling-object probability when a difference between the determined position of the device and the position information of an overpass is greater than a predetermined threshold.

In Example 40, a vehicle is disclosed, including one or more position sensors, configured to provide position sensor data representing a detected position of the vehicle; one or more image sensors, configured to provide image sensor input data representing a sensor image of a vicinity of the vehicle; a database, including position data representing positions of one or more overpasses; and one or more processors, configured to determine from the position sensor data and the database a proximity between the vehicle and an overpass; detect from the image sensor data the overpass and one or more persons on the overpass; determine from the image sensor data a falling-object probability associated with the detected one or more persons on the overpass, according to a first logic; determine from the image sensor data one or more falling-object evasion factors associated with a vicinity of the vehicle; and if the falling-object probability exceeds a predetermined threshold, determine a harm avoidance maneuver based at least on the one or more falling-object evasion factors, according to a second logic, and send an instruction including the harm avoidance maneuver.

In Example 41, the vehicle of Example 40 is disclosed, wherein the one or more processors are further configured to detect from the image sensor data one or more of the following risk factors: a number of persons on the overpass; whether the one or more persons are moving or stationary; a direction faced by the one or more persons relative to the vehicle; an approximate age of any of the one or more persons; a proximity of at least two of the one or more persons; whether any of the one or more persons are wearing a hat; whether any of the one or more persons are wearing a mask; whether any of the one or more persons is riding a bicycle; or any combination of the foregoing; and wherein the one or more processors are configured to determine the falling-object probability using the determined risk factors.

In Example 42, the vehicle of Example 41 is disclosed, wherein the first logic includes assigning a value to one or more of the risk factors and determining a falling-object probability as a sum of the detected risk factors.

In Example 43, the vehicle of any one of Examples 40 to 42 is disclosed, wherein the one or more falling-object evasion factors include one or more of determining a lane of traffic beneath at least one of the one or more persons on the overpass; an availability of an adjacent lane; a velocity of the vehicle; an acceleration of the vehicle; an availability of a road-shoulder or safety area; a velocity of each of one or more vehicles in a vicinity of the vehicle; an acceleration of each of one or more vehicles in a vicinity of the vehicle; or any combination thereof.

In Example 44, the vehicle of any one of Examples 40 to 43 is disclosed, wherein the harm avoidance maneuver includes a change in velocity, acceleration, direction, or any combination thereof, to avoid an area below a person associated with a falling-object probability above the predetermined threshold.

In Example 45, the vehicle of any one of Examples 40 to 44 is disclosed, wherein the second logic includes weighing falling-object probability with at least one of a probability of harm associated with the harm avoidance maneuver; a probability of avoiding an area below a person associated with a falling-object probability above the predetermined threshold if the harm avoidance maneuver is executed; or any combination thereof.

In Example 46, the vehicle of any one of Examples 40 to 45 is disclosed, wherein the one or more processors are further configured to store image data from the one or more image sensors if falling-object probability exceeds the predetermined threshold.

In Example 47, the vehicle of Example 46 is disclosed, wherein the one or more processors are further configured to store video data from the one or more image sensors if falling-object probability exceeds the predetermined threshold.

In Example 48, the vehicle of any one of Examples 40 to 47 is disclosed, wherein the one or more processors are further configured to detect an object falling from the overpass.

In Example 49, the vehicle of Example 48 is disclosed, wherein, if an object falling from the overpass is detected, the one or more processors are further configured to store image sensor data on a memory.

In Example 50, the vehicle of Example 48 is disclosed, wherein, if an object falling from the overpass is detected, the one or more processors are further configured to control a wireless communication vehicle to contact an authority.

In Example 51, the vehicle of any one of Examples 40 to 50 is disclosed, further including one or more position sensors, configured to determine a position of the vehicle and to send position data representing the detected position to the one or more processors; and a database including position information of one or more overpasses; wherein the one or more processors are configured to detect an overpass in a vicinity of the vehicle based on a relationship between the position data from the one or more position sensors and the position information of the one or more overpasses.

In Example 52, the vehicle of Example 51 is disclosed, further including determining the falling-object probability when a difference between the determined position of the vehicle and the position information of an overpass is less than a predetermined threshold, and disabling determination of the falling-object probability when a difference between the determined position of the vehicle and the position information of an overpass is greater than a predetermined threshold.

In Example 53, a method of risk detection and avoidance is disclosed, including detecting from the image sensor data an overpass and one or more persons on the overpass; determining from the image sensor data a falling-object probability associated with the detected one or more persons on the overpass, according to a first logic; determining from the image sensor data one or more falling-object evasion factors associated with a vicinity of a vehicle; and if the falling-object probability exceeds a predetermined threshold, determining a harm avoidance maneuver based at least on the one or more falling-object evasion factors, according to a second logic, and sending an instruction including the harm avoidance maneuver.

In Example 54, the method of risk detection and avoidance of Example 53 is disclosed, further including detecting from the image sensor data one or more of the following risk factors: a number of persons on the overpass; whether the one or more persons are moving or stationary; a direction faced by the one or more persons relative to the vehicle; an approximate age of any of the one or more persons; a proximity of at least two of the one or more persons; whether any of the one or more persons are wearing a hat; whether any of the one or more persons are wearing a mask; whether any of the one or more persons is riding a bicycle; or any combination of the foregoing; and wherein the one or more processors are configured to determine the falling-object probability using the determined risk factors.

In Example 55, the method of risk detection and avoidance of Example 54 is disclosed, wherein the first logic includes assigning a value to one or more of the risk factors and determining a falling-object probability as a sum of the detected risk factors.

In Example 56, the method of risk detection and avoidance of any one of Examples 53 to 55 is disclosed, wherein the one or more falling-object evasion factors include one or more of determining a lane of traffic beneath at least one of the one or more persons on the overpass; an availability of an adjacent lane; a velocity of the vehicle; an acceleration of the vehicle; an availability of a road-shoulder or safety area; a velocity of each of one or more vehicles in a vicinity of the vehicle; an acceleration of each of one or more vehicles in a vicinity of the vehicle; or any combination thereof.

In Example 57, the method of risk detection and avoidance of any one of Examples 53 to 56 is disclosed, wherein the harm avoidance maneuver includes a change in velocity, acceleration, direction, or any combination thereof, to avoid an area below a person associated with a falling-object probability above the predetermined threshold.

In Example 58, the method of risk detection and avoidance of any one of Examples 53 to 57 is disclosed, wherein the second logic includes weighing falling-object probability with at least one of a probability of harm associated with the harm avoidance maneuver; a probability of avoiding an area below a person associated with a falling-object probability above the predetermined threshold if the harm avoidance maneuver is executed; or any combination thereof.

In Example 59, the method of risk detection and avoidance of any one of Examples 53 to 58 is disclosed, further including storing image data from the one or more image sensors if falling-object probability exceeds the predetermined threshold.

In Example 60, the method of risk detection and avoidance of Example 59 is disclosed, further including storing video data from the one or more image sensors if falling-object probability exceeds the predetermined threshold.

In Example 61, the method of risk detection and avoidance of any one of Examples 53 to 60 is disclosed, further including detecting an object falling from the overpass.

In Example 62, the method of risk detection and avoidance of Example 61 is disclosed, wherein, further including storing image sensor data on a memory if an object falling from the overpass is detected.

In Example 63, the method of risk detection and avoidance of Example 62 is disclosed, wherein, further including controlling a wireless communication vehicle to contact an authority if an object falling from the overpass is detected.

In Example 64, the method of risk detection and avoidance of any one of Examples 53 to 63 is disclosed, further including detecting an overpass in a vicinity of the vehicle based on a relationship between the position data from the one or more position sensors and the position information of the one or more overpasses.

In Example 65, the method of risk detection and avoidance of Example 64 is disclosed, further including determining the falling-object probability when a difference between the determined position of the vehicle and the position information of an overpass is less than a predetermined threshold, and disabling determination of the falling-object probability when a difference between the determined position of the vehicle and the position information of an overpass is greater than a predetermined threshold.

In Example 66, a risk detection and avoidance device is disclosed, including one or more image sensors, configured to provide image sensor input data representing a sensor image of a vicinity of the device; and one or more processors, configured to detect from the image sensor data one or more vehicles in a vicinity of the device; determine from the image sensor data a risk probability associated with the detected one or more vehicles, according to a first logic; determine from the image sensor data one or more risk evasion factors associated with a vicinity of the device; and if the risk probability exceeds a predetermined threshold, determine a harm avoidance maneuver based at least on the one or more risk evasion factors, according to a second logic, and send an instruction including the harm avoidance maneuver.

In Example 67, the risk detection and avoidance device of Example 66 is disclosed, wherein the one or more processors are further configured to detect from the image sensor data one or more of the following risk factors: a vehicle changing lanes while traveling at a velocity above a predetermined threshold; a vehicle changing lanes at an acceleration above a predetermined threshold; a change in acceleration above a predetermined threshold; one or more vehicles traveling at a velocity greater than a tolerance above a valid speed limit; one or more vehicles traveling at a velocity less than a tolerance below a valid minimum speed; and wherein the one or more processors are configured to determine the risk probability using the determined risk factors.

In Example 68, the risk detection and avoidance device of Example 67 is disclosed, wherein the first logic includes assigning a value to one or more of the risk factors and determining a risk probability as a sum of the detected risk factors.

In Example 69, the risk detection and avoidance device of any one of Examples 66 to 68 is disclosed, wherein the one or more falling-object evasion factors include one or more of determining an availability of an adjacent lane; a velocity of the device; an acceleration of the device; an availability of a road-shoulder or safety area; a velocity of each of one or more vehicles in a vicinity of the device; an acceleration of each of one or more vehicles in a vicinity of the device; or any combination thereof.

In Example 70, the risk detection and avoidance device of any one of Examples 66 to 69 is disclosed, wherein the harm avoidance maneuver includes a change in velocity, acceleration, direction, or any combination thereof.

In Example 71, the risk detection and avoidance device of any one of Examples 66 to 70 is disclosed, wherein the second logic includes weighing risk probability with at least one of a probability of harm associated with the harm avoidance maneuver; a probability of avoiding an area below a person associated with a risk probability above the predetermined threshold if the harm avoidance maneuver is executed; or any combination thereof.

In Example 72, the risk detection and avoidance device of any one of Examples 66 to 71 is disclosed, wherein the one or more processors are further configured to store image data from the one or more image sensors if risk probability exceeds the predetermined threshold.

In Example 73, the risk detection and avoidance device of Example 72 is disclosed, wherein the one or more processors are further configured to store video data from the one or more image sensors if risk probability exceeds the predetermined threshold.

In Example 74, a non-transient computer readable medium is disclosed, which is configured to cause one or more processors, when executed, to carry out the method of any one of Examples 53 to 65.

In Example 75, a method of risk detection and avoidance is disclosed, including providing image sensor input data representing a sensor image of a vicinity of the device; detecting from the image sensor data one or more vehicles in a vicinity of the device; determining from the image sensor data a risk probability associated with the detected one or more vehicles, according to a first logic; determining from the image sensor data one or more risk evasion factors associated with a vicinity of the device; and if the risk probability exceeds a predetermined threshold, determining a harm avoidance maneuver based at least on the one or more risk evasion factors, according to a second logic, and send an instruction including the harm avoidance maneuver.

In Example 76, the method of risk detection and avoidance of Example 75 is disclosed, further including detecting from the image sensor data one or more of the following risk factors: a vehicle changing lanes while traveling at a velocity above a predetermined threshold; a vehicle changing lanes at an acceleration above a predetermined threshold; a change in acceleration above a predetermined threshold; one or more vehicles traveling at a velocity greater than a tolerance above a valid speed limit; one or more vehicles traveling at a velocity less than a tolerance below a valid minimum speed; and wherein the one or more processors are configured to determine the risk probability using the determined risk factors.

In Example 77, the method of risk detection and avoidance of Example 76 is disclosed, wherein the first logic includes assigning a value to one or more of the risk factors and determining a risk probability as a sum of the detected risk factors.

In Example 78, the method of risk detection and avoidance of any one of Examples 75 to 77 is disclosed, wherein the one or more falling-object evasion factors include one or more of determining an availability of an adjacent lane; a velocity of the device; an acceleration of the device; an availability of a road-shoulder or safety area; a velocity of each of one or more vehicles in a vicinity of the device; an acceleration of each of one or more vehicles in a vicinity of the device; or any combination thereof.

In Example 79, the method of risk detection and avoidance of any one of Examples 75 to 78 is disclosed, wherein the harm avoidance maneuver includes a change in velocity, acceleration, direction, or any combination thereof.

In Example 80, the method of risk detection and avoidance of any one of Examples 75 to 79 is disclosed, wherein the second logic includes weighing risk probability with at least one of a probability of harm associated with the harm avoidance maneuver; a probability of avoiding an area below a person associated with a risk probability above the predetermined threshold if the harm avoidance maneuver is executed; or any combination thereof.

In Example 81, the method of risk detection and avoidance of any one of Examples 75 to 80 is disclosed, further including storing image data from the one or more image sensors if risk probability exceeds the predetermined threshold.

In Example 82, the risk detection and avoidance device of Example 81 is disclosed, further including storing video data from the one or more image sensors if risk probability exceeds the predetermined threshold.

In Example 83, a non-transient computer readable medium is disclosed, which is configured to cause one or more processors, when executed, to carry out the method of any one of Examples 75 to 82.

In Example 84, a means of risk detection and avoidance is disclosed, comprising one or more image sensing means, configured to provide image sensor input data representing a sensor image of a vicinity of the device; and one or more processing means, configured to detect from the image sensor data an overpass and one or more persons on the overpass; determine from the image sensor data a falling-object probability associated with the detected one or more persons on the overpass, according to a first logic; determine from the image sensor data one or more falling-object evasion factors associated with a vicinity of the device; and if the falling-object probability exceeds a predetermined threshold, determine a harm avoidance maneuver based at least on the one or more falling-object evasion factors, according to a second logic, and send an instruction comprising the harm avoidance maneuver.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

What is claimed is:

1. A risk detection and avoidance device, comprising
one or more image sensors, configured to provide image sensor input data representing a sensor image of a vicinity of the device; and
one or more processors, configured to:
detect from the image sensor data an overpass and one or more persons on the overpass;
determine from the image sensor data a falling object probability associated with the detected one or more persons on the overpass, according to a first logic;
determine from the image sensor data one or more falling object evasion factors associated with a vicinity of the device; and
if the falling object probability exceeds a predetermined threshold, determine a harm avoidance maneuver based at least on the one or more falling object evasion factors, according to a second logic, and send an instruction comprising the harm avoidance maneuver.

2. The risk detection and avoidance device of claim 1, wherein the first logic includes assigning a value to one or more of the risk factors and determining the falling-object probability as a sum of the detected risk factors.

3. The risk detection and avoidance device of claim 1, wherein the one or more falling-object evasion factors include one or more of determining a lane of traffic beneath at least one of the one or more persons on the overpass; an availability of an adjacent lane; a velocity of the device; an acceleration of the device; an availability of a road-shoulder or safety area; a velocity of each of one or more vehicles in a vicinity of the device; an acceleration of each of one or more vehicles in a vicinity of the device; or any combination thereof.

4. The risk detection and avoidance device of claim 1, wherein the harm avoidance maneuver includes a change in velocity, acceleration, direction, or any combination thereof, to avoid an area below a person associated with a falling-object probability above the predetermined threshold.

5. The risk detection and avoidance device of claim 1, wherein the second logic includes weighing falling-object probability with at least one of a probability of harm associated with the harm avoidance maneuver; a probability of avoiding an area below a person associated with a falling-object probability above the predetermined threshold if the harm avoidance maneuver is executed; or any combination thereof.

6. The risk detection and avoidance device of claim 1, wherein the one or more processors are further configured to store image data from the one or more image sensors if falling-object probability exceeds the predetermined threshold.

7. The risk detection and avoidance device of claim 1, wherein the one or more processors are further configured to detect an object falling from the overpass.

8. The risk detection and avoidance device of claim 7, wherein, if an object falling from the overpass is detected, the one or more processors are further configured to control a wireless communication device to send a wireless signal.

9. The risk detection and avoidance device of claim 1, further comprising one or more position sensors, configured to determine a position of the device and to send position data representing the detected position to the one or more processors; and
a database comprising position information of one or more overpasses; wherein the one or more processors are configured to detect an overpass in a vicinity of the device based on a relationship between the position data from the one or more position sensors and the position information of the one or more overpasses.

10. A vehicle, comprising
one or more image sensors, configured to provide image sensor input data representing a sensor image of a vicinity of the vehicle; and
one or more processors, configured to:
detect from the image sensor data an overpass and one or more persons on the overpass;
determine from the image sensor data a falling-object probability associated with the detected one or more persons on the overpass, according to a first logic;
determine from the image sensor data one or more falling-object evasion factors associated with a vicinity of the vehicle; and
if the falling-object probability exceeds a predetermined threshold, determine a harm avoidance maneuver based at least on the one or more falling-object evasion factors, according to a second logic, and send an instruction comprising the harm avoidance maneuver.

11. The vehicle of claim 10, wherein the first logic includes assigning a value to one or more of the risk factors and determining a falling-object probability as a sum of the detected risk factors.

12. A method of risk detection and avoidance, comprising
detecting from the image sensor data an overpass and one or more persons on the overpass;
determining from the image sensor data a falling-object probability associated with the detected one or more persons on the overpass, according to a first logic;
determining from the image sensor data one or more falling-object evasion factors associated with a vicinity of a vehicle; and
if the falling-object probability exceeds a predetermined threshold, determining a harm avoidance maneuver based at least on the one or more falling-object evasion factors, according to a second logic, and sending an instruction comprising the harm avoidance maneuver.

13. The method of risk detection and avoidance of claim 12, further comprising detecting from the image sensor data one or more of the following risk factors: a number of persons on the overpass; whether the one or more persons are moving or stationary; a direction faced by the one or more persons relative to the vehicle; an approximate age of any of the one or more persons; a proximity of at least two of the one or more persons; whether any of the one or more persons are wearing a hat; whether any of the one or more persons are wearing a mask; whether any of the one or more persons is riding a bicycle; or any combination of the foregoing; and wherein the one or more processors are configured to determine the falling-object probability using the determined risk factors.

14. The method of risk detection and avoidance of claim 12, wherein the first logic includes assigning a value to one or more of the risk factors and determining a falling-object probability as a sum of the detected risk factors.

15. The method of risk detection and avoidance of claim 12, wherein the one or more falling-object evasion factors include one or more of determining a lane of traffic beneath at least one of the one or more persons on the overpass; an availability of an adjacent lane; a velocity of the vehicle; an acceleration of the vehicle; an availability of a road-shoulder or safety area; a velocity of each of one or more vehicles in a vicinity of the vehicle; an acceleration of each of one or more vehicles in a vicinity of the vehicle; or any combination thereof.

16. The method of risk detection and avoidance of claim 12, wherein the one or more falling-object evasion factors include one or more of determining an availability of an adjacent lane; a velocity of the device; an acceleration of the device; an availability of a road-shoulder or safety area; a velocity of each of one or more vehicles in a vicinity of the device; an acceleration of each of one or more vehicles in a vicinity of the device; or any combination thereof.

17. The method of risk detection and avoidance of claim 12, wherein the harm avoidance maneuver includes a change in velocity, acceleration, direction, or any combination thereof.

18. A risk detection and avoidance device, comprising
one or more image sensors, configured to provide image sensor input data representing a sensor image of a vicinity of the device; and
one or more processors, configured to:
detect from the image sensor data one or more vehicles in a vicinity of the device;
determine from the image sensor data a risk probability associated with the detected one or more vehicles, according to a first logic;
determine from the image sensor data one or more risk evasion factors associated with a vicinity of the device; and
if the risk probability exceeds a predetermined threshold, determine a harm avoidance maneuver based at least on the one or more risk evasion factors, according to a second logic, and send an instruction comprising the harm avoidance maneuver.

19. The risk detection and avoidance device of claim 18, wherein the one or more processors are further configured to detect from the image sensor data one or more of the following risk factors: a vehicle changing lanes while traveling at a velocity above a predetermined threshold; a vehicle changing lanes at an acceleration above a predetermined threshold; a change in acceleration above a predetermined threshold; one or more vehicles traveling at a velocity greater than a tolerance above a valid speed limit; one or more vehicles traveling at a velocity less than a tolerance below a valid minimum speed; and wherein the one or more processors are configured to determine the risk probability using the determined risk factors.

20. The risk detection and avoidance device of claim 18, wherein the first logic includes assigning a value to one or more of the risk factors and determining a risk probability as a sum of the detected risk factors.
